(19) United States
(12) Patent Application Publication
(10) Pub. No.: US 2003/0120971 A1
(43) Pub. Date: Jun. 26, 2003

(54) Process for performance testing computer equipment accessible via a telecommunications network

(75) Inventor: Jean-Pierre Christie, Toulouse (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: I-TIPI S.A., Issy-les-Moulineaux (FR)

(21) Appl. No.: 10/300,989

(22) Filed: Nov. 21, 2002

Related U.S. Application Data
(63) Continuation of application No. PCT/FR01/01580, filed on May 22, 2001.

(30) Foreign Application Priority Data
May 22, 2000 (FR) FR00/06519

(51) Int. Cl. H02H 3/05

(52) U.S. Cl. 714/25

(57) ABSTRACT

A process for executing tests of computer equipment accessible via a telecommunications network by a multiplicity of host equipment units including developing a test scenario; distributing an information object containing the test scenario via said network to a population of host equipment units; synchronizing the start of the test on the population of host equipment units; executing a sequence of actions constituting the test scenario with each of the host equipment units of the population; and collecting results of the tests originating from each of the host equipment units of the population.

### RELATED APPLICATION

This is a continuation of International Application No. PCT/FR01/01580, with an international filing date of May 22, 2001, which is based on French Patent Application No. 00/06519, filed May 22, 2000.

### FIELD OF THE INVENTION

This invention pertains to the field of performance testing computer equipment and, more particularly, of Internet sites (referred to below as “Web sites”).

### BACKGROUND

Webmasters want to have available effective means for verifying the performance of the site. Performance testing of a Web site, also referred to as “load testing”, allows confirmation that the site provides its users with satisfactory availability even when a very large number of users are connected simultaneously. Such a requirement is an integral part of Internet services.

The solutions of the state of the art are based on the implementation of simulation programs. The connections to the Web site are generated by a software automaton from the capture of information collected either at the level of the network or at the level of the navigator used by the internaut for connecting to the server to be tested.

WO 00/019320 describes an agent emulation system for evaluating a server. To simulate the operating characteristics of a final user, a software agent executes and attempts to exploit an information resource network by simulation of a transaction. The results of this simulated transaction and the results of other transaction simulations performed by other software agents are transmitted to a central programmed system for recording and analysis.

These simulations, based on the use of an agent, are not emulated simultaneously and, thus, do not guarantee the reality of the server's functioning nor the reliability of the results of this simulation. Each agent only executes a single task and the tasks are not synchronized with each other.

U.S. Pat. No. 5,974,572 describes a program for generating local loading tests. U.S. Pat. No. 5,764,906 describes an electronic resource denotation, request and provision system which allows a user to localize the information on a distributed computer system or a network such as the Internet by knowing or guessing a short mnemonic pseudonym of an electronic resource without the user having to know the denotation of the physical or other location, such as the universal resource location (URL) of the desired resource. The system comprises a client computer, a local server, a central attachment server, a value-added server and a root server.

The known simulation processes have notable limitations, particularly the difficulty of reproducing a large number of connections and the intrinsic inability to test the real behavior of a Web site.

It would therefore be advantageous to resolve these disadvantages.

### SUMMARY OF THE INVENTION

This invention relates to a process for executing tests of computer equipment accessible via a telecommunications network by a multiplicity of host equipment units including developing a test scenario, distributing an information object containing the test scenario via the network to a population of host equipment units, synchronizing the start of the test on the population of host equipment units, executing a sequence of actions constituting the test scenario with each of the host equipment units of the population, and collecting results of the tests originating from each of the host equipment units of the population.

### BRIEF DESCRIPTION OF THE INVENTION

Better understanding of the present invention will be obtained from the description below of a nonlimitative example of implementation with reference to the attached drawing in which:

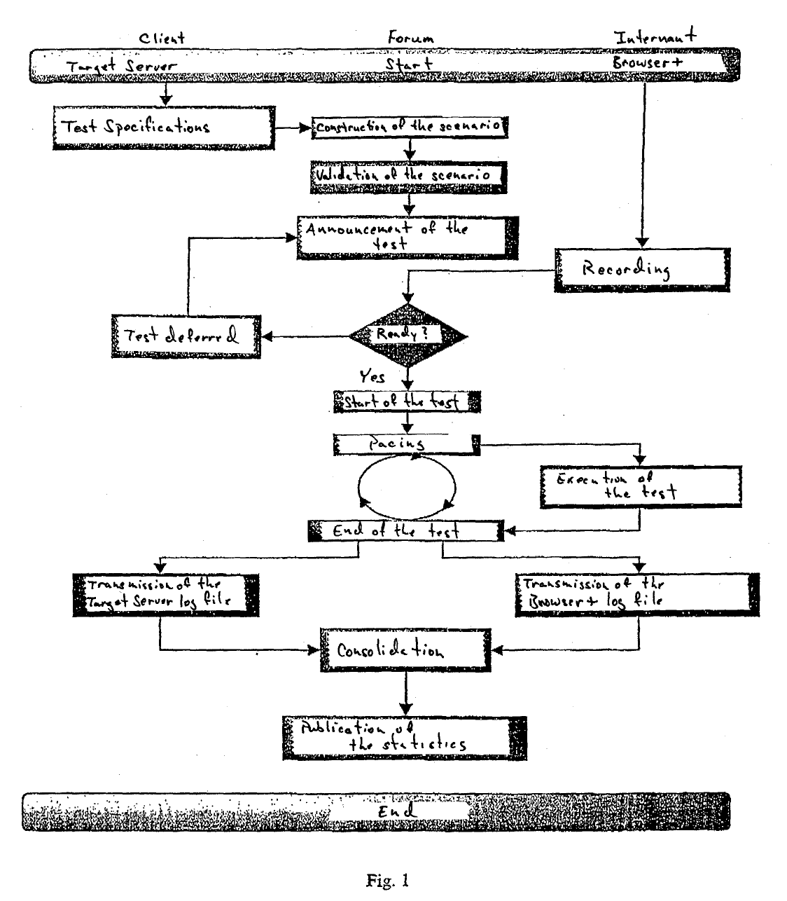

FIG. 1 represents a schematic view of the invention; and

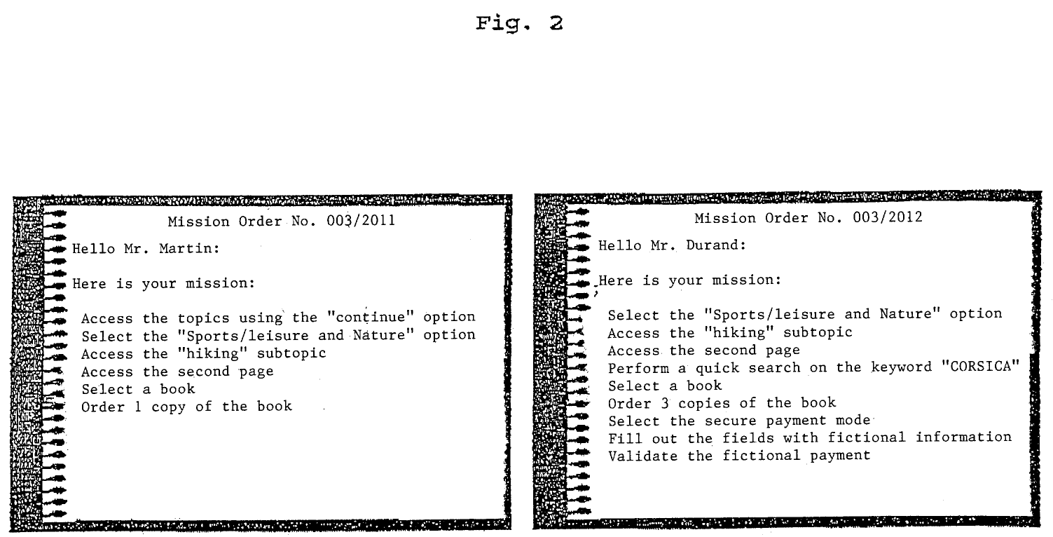

FIG. 2 represents a view of an example of a mission order.

### DETAILED DESCRIPTION

The invention pertains in its broadest sense to a process for executing tests of computer equipment accessible via a telecommunications network by a multiplicity of host equipment units, characterized in that it comprises a step of developing a test scenario, of distribution via the network to a population of host equipment units of an information object containing the test scenario, a step of synchronization of the start of the test on a population of host equipment units, a step of execution by each of the host equipment units of the population of the sequence of actions constituting the test scenario and a step of collecting the results of the tests originating from each of the host equipment units of the population.

Load testing according to the invention completely overcomes the limitations linked to the use of automatons. The process is based on the use of a program called “test server” which provides supervision of the organization and progression of the tests, and distribution and analysis of the actions performed from the host equipment units. The Tester Internaut is equipped with and uses a Host Computer to implement the system which is an object of the invention.

Launching the tests, notably starting the sequence of actions to be performed by each host equipment unit is synchronized for the totality of the host equipment units, the test server delivering a launching signal or command.

Execution of these actions is then performed under natural conditions by each of the host equipment units which makes it possible to realistically take into account the artifacts associated with the network and the equipment.

The process according to the invention advantageously comprises a step preceding execution of the tests consisting of loading on the host equipment units a program for the execution of the tests equipped with a navigation function forced by the test server.

According to a variant of aspects of the invention, the host equipment units are equipped with a computer program masking the address of the test sites. According to another variant, the host equipment units are equipped with a computer program masking the source code of the pages displayed of the test sites.

The test server advantageously comprises a client information input module, a test planning module and a module for analysis of the test instruction file and automatic generation of information required for the constitution of the mission orders used by the internauts for performing the tests.

The mission order designates the succession of operations to be performed by the internaut, for example, the time and name of the scenario(s) to execute. The address of the site is preferably masked. The mission order is associated with one or more scenarios pacing the succession of the actions that the Web surfer must execute. This pacing enables synchronization of all or part of the internauts' actions.

According to another variant, the test server furthermore comprises a test implementation module for automatic transmission of convocations and censuses of tester internauts, means for real time planning of the tests in a series and the registration of sign-ups and the issuance of tokens, as well as a module for the launching and pacing of the tests.

The following terms will be understood to have the following meanings in the context of the invention:

Test: Coordinated and synchronized action of a set of internauts during a defined period of time with the purpose of testing the loading of a Web site. The number of internauts participating in tests varies in relation to the client's request and the immediate availability of the internauts;

Test campaign: This is the functional test unit from the client's point of view. A test often reveals one or more anomalies which lead to technical modifications. It is then necessary to retest one or more times to arrive at a satisfactory result. The set of these tests constitutes the campaign;

Test series: Tests are performed in the framework of a consecutive series-for example, 12 consecutive tests-performed according to a defined frequency. Each test of a series pertains to a different target site. An internaut can participate in multiple tests of the same series. Multiple series can be executed simultaneously. The test series is a purely organizational information of the invention;

Mission: The mission is the test from the point of view of the internaut. Each internaut has as his mission participating in a test or a series of tests;

Mission order: This is the complete descriptive of that which the internaut must do during the test. A mission order can contain the descriptions of multiple test scenarios;

Test scenario: Elementary sequential description in natural language (French, English or any other language comprehensible by the internaut) of an indivisible series of operations that the internaut must execute during his mission;

Host equipment: Set of hardware and software used by an internaut to execute a mission via the network:

Client: The company, person or organization that employs the invention for the load testing of its Web site:

Assiduity: Quality of an internaut defined by the number of tests already executed over a defined period of time;

Internaut or tester: Person who participates in implementing one or more tests. The internaut executes a mission. The tester internauts are defined in terms of their assiduity. This parameter allows the test server to estimate the possibilities of implementation of tests and regulate taking into account of spontaneous arrivals;

Session: A session corresponds to the time elapsing between the moment when the internaut connects to (connection) the target site and the moment when he disconnects (disconnection) from the target site;

Connection: The connection is the tester's entry into effective action. It is executed by means of the scenario executor (defined below). When the connection is established between a tester and the target site, the number of active tester internauts is incremented by 1;

Pacing: Process used by the invention to distribute loading according to parameters of the type time, geographic distribution and also characteristic of host equipment units. It allows extremely precise control of the test execution conditions;

Token: Process which enables registration of the internaut for a participation in a test and activation of the internaut's scenario executor for the given test;

Test Web site: Web site which houses software components for implementing the invention, in particular, the test server;

Test server: Software module installed on the test Web site, which records the clients' requests, plans the tests, generates the required information, organizes and coordinates the execution of the tests;

Scenario executor: Specific software module used by the internaut to execute his mission;

Databank: List of data (profession, postal code, etc.) which enables definition of personalized sessions;

Login: Unique identifier for each internaut or for each Client;

Password: Password proprietary to each internaut or each Client;

Target site: This is literally the Web site to be tested;

Log file: A file of the target site containing the parameters enabling upon completion of a session reconstitution of the major steps of the test and execution of the analysis of the performance of the target site.

The process according to the invention consists of executing load tests of Web sites employing internauts who execute a series of operations referred to as a scenario in a defined period of time, according to a defined order and synchronization and controlled by a set of programs.

The diagram constituting FIG. 1 shows the principal steps of implementation of the invention.

Step 1: Request for Test or Test Campaign.

The clients sign up for a test request via the test server described below. They perform by means of their usual navigator the following operations:

Ordering a test campaign or a unitary test.

Description of the test instructions in a line form.

Note: this phase is not obligatory to implement of the invention. The clients can sign-up offline or in an assisted manner (e.g., via a call center).

Step 2: Development of the Constitutive Elements of a Test.

The test scenario is a logical linking of operations corresponding to a target-site functionality. Each scenario is constituted of steps. For example, the following scenarios are possible on a target site selling books:

Scenario 1: Access to the information

Step 1: Access the topics by the “continue” option,

Step 2: Select the option “Sports/recreation and nature”,

Step 3: Access under the “hiking” subtopic,

Step 4: Access the second page.

Scenario 2: Conventional Ordering of a Book

Step 1: Selection of an article,

Step 2: Select a book,

Step 3: Order 1 copy of the book.

Scenario 3: Ordering using quick search

Step 1: Perform a quick search on the keyword “CORSICA”,

Step 2: Select a book,

Step 3: Order 3 copies of the book.

Scenario 4: Secure payment

Step 1: Select the secure payment mode,

Step 2: Fill out the information with the predefined fictional information,

Step 3: Validate the fictional payment.

Scenario 5: Cancellation of a Payment

Step 1: Cancel the command using the “back” button.

A scenario is constituted by:

A formatted text described the actions to be performed during the test,

Data (for example a list of logins and passwords which will be distributed among the tester internauts),

Data lists or databanks, e.g., a list of articles to order.

The step comprised of defining the profiles of the internauts has the purpose of organizing the scenarios by approaching as close as possible to the different requests performed simultaneously by a multiplicity of internauts in a loading of the target site.

### EXAMPLE

10% of the internauts will perform successively the scenarios: S1, S2,

60% of the internauts will perform successively the scenarios: S1, S2, S4,

30% of the internauts will perform successively the scenarios: S1, S3, S5.

The process according to the invention thus also comprises a test parameter definition step:

Number of tester internauts,

Geographic distribution,

Distribution by type of connection of the host equipment units (modem, cable, etc.),

Load stages (for example, 10 additional tester internauts every 10 minutes).

The test server then generates the technical elements of the test comprising the following operations:

Analysis of the request and proposal of dates of implementation in relation to the general planning of the tests;

Analysis of the constitutive elements of the test and automatic generation of the mission orders (interpretation of the profiles, the data and the databanks).

The following step pertains to downloading the scenario executor by the internaut. The internaut must download the scenario executor to his computer to be able to participate in the tests. This operation is performed at sign up.

According to a defined frequency, the test server communicates the calendar of the next tests via electronic mail (E-mail) or by other means (portable telephones, SMS or WAP messages, etc.) for the internauts who have already signed up and on the test Web site for the others.

The description below pertains to the progression of a test series:

Arrival of the internauts;

The internauts connect to the test Web site and access the test server to display the available tests;

The internauts sign up for the tests of their choice (receipt of one token per test).

Comment: These two operations can be performed at any time (e.g., a week in advance).

Each time that the internaut launches the scenario executor, the internaut is automatically positioned on a page of the test Web site which informs him, when applicable, of the time and date of this next test. This page can show a test which is underway.

Several minutes before the test, the internaut receives information on the type of test that he must perform;

The internaut listens to and/or displays the countdown that precedes the test to execute.

When the countdown is terminated and when applicable in relation to the pacing determined by the test server, the internaut is invited to start the test. The internaut is automatically redirected to the target site without being aware of the welcome page and receives a mission order on the screen and/or via the speakers connected to or incorporated in his computer.

The entry into action of the internauts is entirely controlled by the test server. According to the Client's requests and the text execution conditions, the test server can distribute loading over a determined duration of time and geographic distribution and monitor pacing of the connections.

FIG. 1 represents an example of a mission order.

Execution of the Test

The internaut performs one by one the actions indicated on the mission order.

All of the parameters linked to the execution of the test are stored in memory by the mission order executor. The internaut moreover has the possibility of making comments of a qualitative nature on his mission.

End of the Test

The internaut is brought back to the test Web site on a page which informs him, among other things, how much he has won. The internaut can then display and/or listen to, if applicable, the countdown to the next test.

Transmission of the Information

At the end of the test, the scenario executor transmits all of the test-related information to the test server. The information recorded in the log file of the target site is also transmitted. The test server publishes the statistics of the test and makes them available to the Client.

Important note: The information stored in memory by the scenario executor is not accessible by the internaut. This ensures total confidentiality and total reliability.

Presentation of the Software Components

The software architecture used for implementation of the tests is essentially constituted by two modules. The test server and the scenario executor. Four communication phases can be identified over the course of execution of a test:

Phase of transmission of information from the test server to the scenario executor for performance of the test. This phase defines the test conditions;

Phase of limited and optimized exchange during the test so as to monitor the progression of the loading caused by the internauts' connections. This phase also allows the test server to control the pacing of the connections;

Phase of transmission of the information generated by the scenario executor to the test server for producing the test results;

Phase of transmission of information from the target site to the test server in order to consolidate the information collected during the preceding phase (recovery of the client log file).

The guiding principle of the internauts for execution of a test is the following:

Connection to the test Web site for the pre-test phase (registration, distribution of tokens, countdown),

Direct connection to the target site with limited transmission of information to the test server,

Return to the test Web site.

Description of the Scenario Executor

The scenario executor is the program module used by the internaut to perform a test. From a use point of view, this module has certain characteristics of a navigator with the essential difference based on the fact that navigation is forced by the test server. The principal functions are the following:

Function of activation (taking into account the token);

Function of display of skins (visual personalization of the tool);

Function of announcement of test start;

Function of synchronized display of the mission order;

Function of recording the internaut's actions;

Function of communication with the test server;

Functions of confidentiality for the client;

Masking the address of the target site;

Masking the source code of the page displayed.

The test server is the principal program system used in the framework of the implementation of the invention. It is the automated control system which controls the progression of the tests. It is constituted by the following principal modules:

Client-information input module;

Test planning module;

Module for analysis of the descriptive test instruction file and automatic generation of the information needed for constitution of the mission orders;

Test execution module

This module controls:

The automatic sending of internaut convocation and census;

Real time planning of the tests in a series (generation of the optimal test sequence);

Recording of the sign-ups and issuance of the tokens;

Count down and launching of the test with parameterizable pacing process;

Module for consolidation and generation of statistics linked to the test;

Test instrument panel module: During the test period, the Client can display information on the test in real time (number of internauts, geographic distribution, etc.).

The process can optionally have additional operations:

1) Generation of scenarios from analysis of the test site logs by analysis of the most used pathways and the most commonly performed operations. This operation enables automation or guiding of the construction of scenarios from the result of the connection files and determination of the scenarios corresponding to the most frequent uses.

2) Implementation of a standards system which constitutes a reference host equipment unit in the sense of the patent. A scenario executor installed on this equipment, itself connected to the test site by a constant speed link, makes it possible to obtain independent measurements of the variations in response time due to the heterogeneity of the intermediary equipment situated between each of the other host equipment units and the test site.

3) The scenario executor installed on the host equipment unit comprises a function of capturing the pathway taken to the test site as well as the time required. This constitutes a dynamic standards system of the loading time as a function of the access provider.

4) The information returned by the scenario executor can be corroborated by the information originating from the test site log files.

1. A process for executing tests of computer equipment accessible via a telecommunications network by a multiplicity of host equipment units comprising:
developing a test scenario;
distributing an information object containing said test scenario via said network to a population of host equipment units;
synchronizing the start of the test on said population of host equipment units;
executing a sequence of actions constituting the test scenario with each of the host equipment units of the population; and
collecting results of the tests originating from each of the host equipment units of the population.

2. The process according to claim 1, further comprising loading on the host equipment units a program for communication with the test server preceding the execution of the test.

3. The process according to claim 1, wherein the host equipment units are equipped with a computer program masking the address of the test sites.

4. The process according to claim 1, wherein the host equipment units are equipped with a specific drive program masking the source code of pages displayed of the test sites.

5. The process according to claim 1, wherein the test server is controlled by a computer program comprising a client information input module, a statistical test planning module and a module analyzing a test instruction file to automatically generate information for the mission orders.

6. The process according to claim 5, wherein the test server is controlled by a computer program comprising a test implementation module for automatic transmission of convocations and censuses of tester internauts, means for real time planning of the tests in a series and the registration of sign-ups and the issuance of tokens; and
a module for launching and pacing the tests.

7. The process according to claim 1, further comprising recording connection files (log) on a target site for preparation of a scenario.

8. The process according to claim 1, further comprising executing a scenario installed on a reference host equipment unit itself connected to a test site by a constant speed link to obtain independent measurements of variations in response time due to heterogeneity of intermediary equipment situated between each of the other host equipment units and the test site.

9. The process according to claim 8, wherein the scenario executor installed on the host equipment unit comprises a function of capturing a pathway taken to the test site and the time required.

10. A computer system capable of implementing the process according to claim 1, comprising a server provided with means for connection to a network, and means for synchronous launching of a scenario previously loaded on the host equipment units connected to said network, the server comprising means for recording the results on a target scenario activation site.
